(19) United States
(12) Patent Application Publication
(10) Pub. No.: US 2022/0278328 A1
(43) Pub. Date: Sep. 1, 2022

(54) Biocarbon Cathode Materials with Heterocyclic Aromatic Rings Bonded to Sulfur

(71) Applicant: Zeta Energy LLC, Houston, TX (US)

(72) Inventors: Abdul-Rahman Olabode Raji, Houston, TX (US); Tuo Wang, Houston, TX (US); Rodrigo Villegas Salvatierra, Houston, TX (US)

(21) Appl. No.: 17/681,597

(22) Filed: Feb. 25, 2022

Related U.S. Application Data
(60) Provisional application No. 63/154,102, filed on Feb. 26, 2021.

(51) Int. Cl. H01M 4/583; H01M 4/38; H01M 4/62

(52) U.S. Cl. CPC H01M 4/583; H01M 4/38; H01M 4/625; H01M 2004/021

(57) ABSTRACT

Described are sulfurized-carbon particles, and methods of making them, for use in cathodes of energy-storage devices. In the material that makes up the particles, those carbon atoms with the adjacent sulfur atoms are bonded to the adjacent sulfur atoms via carbon-sulfur bonds. The methods rely on readily available biological materials and sulfur. Biological materials, products of living cells, are made largely of organic macromolecules; namely, carbohydrates, lipids, proteins, and nucleic acids. In a cathode, most of the carbon and nitrogen atoms in the carbon-sulfur is incorporated into heterocyclic aromatic rings that strongly bind the sulfur and promote electrical conductivity.

### BACKGROUND

An electric battery includes one or more electric cells. Each cell includes a positive terminal (cathode) and a negative terminal (anode) physically separated by an ion conductor (electrolyte). When a cell is discharged to power an external circuit, the anode supplies negative charge carriers (electrons) to the cathode via the external circuit and positive charge carriers (cations) to the cathode via the internal electrolyte. During charging, an external power source drives electrons from the cathode to the anode via the power source and the resultant charge imbalance pulls cations from the cathode to the anode via the electrolyte.

Lithium-ion (Li-ion) cells store charge in the anode as Li cations (aka Li ions). Li-ion cells are rechargeable and ubiquitous in mobile communications devices and electric vehicles due to their high energy density, a lack of memory effect, and low self-discharge rate. Lithium-metal cells, in contrast, store charge in the anode as lithium metal. Li-metal cells have superior power density but are generally not rechargeable. Lithium ions are the positive charge carriers that travel to and are stored in the cathode during discharge in both Li-ion and Li-metal cells.

Li-ion and Li-metal cells offer excellent performance. There nevertheless exist demands for improvements along every metric of battery price and performance. For example, the cathodes in popular lithium-based NMC (Nickel Manganese Cobalt oxide) and NCA (Nickel Cobalt Aluminum oxide) cells include cobalt and nickel, both of which are mined at considerable financial and environmental cost. These materials are not distributed evenly across the globe, leading to fears of scarcity, supply disruptions, and concomitant political and economic instabilities. Alternative cathode chemistries, such as iron phosphate, address these concerns but provide significantly lower energy densities. There is significant demand for alternative cathode chemistries that address these and other shortcomings.

### BRIEF DESCRIPTION OF THE DRAWINGS

The detailed description is illustrated by way of example, and not by way of limitation, in the figures of the accompanying drawings and in which like reference numerals refer to similar elements and in which:

FIG. 1A includes a thermogravimetric (TG) plot 100 and differential scanning calorimetric (DSC) plot 110 of a precursor containing walnut shell as the predominant carbon source.

FIG. 1B includes a TG plot 120 and DSC plot 130 of sulfurized biocarbon made from precursor containing walnut shell as the predominant carbon source.

FIG. 2 depicts five Raman spectra 200A-200E of sulfurized biocarbon made from precursor containing walnut shell as the predominant carbon source.

FIG. 3A includes a TG plot 300 and a DSC plot 310 of biomolecules made from walnut shell.

FIG. 3B includes a TG plot 320 and DSC plot 330 of sulfur.

FIG. 4A includes a TG plot 400 and DSC plot 410 of sulfurized biocarbon made from precursor containing walnut shell as the predominant carbon source.

FIG. 4B includes a TG plot 420 and DSC plot 430 of sulfurized biocarbon made from precursor containing walnut shell as the predominant carbon source.

FIG. 4C includes a TG plot 440 and DSC plot 450 of sulfurized biocarbon made from precursor containing walnut shell as the predominant carbon source.

FIG. 5A includes a TG plot 500 and DSC plot 510 of a precursor containing onion as the predominant carbon source.

FIG. 5B includes a TG plot 520 and DSC plot 530 of sulfurized biocarbon made from precursor containing onion as the predominant carbon source.

FIG. 6 depicts five Raman spectra 600A-600E of sulfurized biocarbon made from precursor containing onion as the predominant carbon source.

FIG. 7 includes a TG plot 700 and DSC plot 710 of sulfurized biocarbon made from precursor containing garlic as the predominant carbon source.

FIG. 8 depicts five Raman spectra 800A-800E of sulfurized biocarbon made from precursor containing garlic as the predominant carbon source.

FIG. 9A includes a TG plot 900 and a DSC plot 910 of precursor containing coffee extract as the predominant source of carbon.

FIG. 9B includes a TG plot 920 and DSC plot 930 of sulfurized biocarbon made from precursor containing coffee extract as the predominant carbon source.

FIG. 10 depicts five Raman spectra 1000A-1000E of sulfurized biocarbon made from precursor containing coffee extract as the predominant carbon source.

FIG. 11A includes a TG plot 1100 and DSC plot 1110 of a precursor containing collagen as the predominant carbon source.

FIG. 11B includes a TG plot 1120 and DSC plot 1130 of sulfurized biocarbon made from precursor containing collagen as the predominant carbon source.

FIG. 12A includes a TG plot 1200 and DSC plot 1210 of a precursor containing whey as the predominant carbon source.

FIG. 12B includes a TG plot 1220 and DSC plot 1230 of sulfurized biocarbon made from precursor containing whey as the predominant carbon source.

### DETAILED DESCRIPTION

Described are methods of making sulfurized-carbon material (e.g. sulfurized-carbon particles) that can be used to make electrodes for energy-storage devices (e.g., to make cathodes in alkali-metal electrochemical cells). In the material, those carbon atoms with the adjacent sulfur atoms are bonded to the adjacent sulfur atoms via carbon-sulfur bonds. The methods rely on readily available biological materials and sulfur. Biological materials, products of living cells, are made largely of organic macromolecules; namely, carbohydrates, lipids, proteins, and nucleic acids.

As with other organic molecules, carbon is a fundamental component of organic macromolecules. Sulfurized carbon is made by mixing powders of sulfur and one or more biological material and heating the mixture to a temperature sufficient to decompose the biological material, freeing the carbon atoms to bond with the sulfur via carbon-sulfur bonds. Sulfurized carbon thus formed, hereafter “sulfurized biocarbon” to reflect the biological origin, is then incorporated into a cell electrode as e.g. a sulfurized-carbon cathode for a lithium-based (Li-ion or Li-metal) energy-storage device.

Electrodes can include sulfurized biocarbon that includes nitrogen e.g. from the biological carbon source material. Most of the carbon atoms and most of the nitrogen atoms in the biocarbon can be incorporated into heterocyclic aromatic rings that are bonded to the sulfur atoms via carbon-sulfur chemical bonds. The strong attachments of the sulfur to the aromatic rings hinders the development and release of polysulfides that would otherwise reduce storage capacity and increase internal resistance.

Sulfur atoms bonded to the aromatic rings can be described as primary and secondary. Primary sulfur atoms are those that are adjacent to at least one carbon atom, adjacent in this context meaning without intervening atoms. Most of the primary sulfur atoms are covalently bonded to at least one carbon atom. Secondary sulfur atoms are those that are separated from all carbon atoms by at least one intervening atom. Most of the sulfur atoms are of the primary variety, and the tight bonding to the carbon increases the temperature stability of the sulfurized biocarbon. The combined weight of the primary and secondary sulfur atoms is over 10% of the sulfurized biocarbon. Also stabilizing, most of the secondary sulfur atoms are covalently bonded to at least one of the primary sulfur atoms either directly or via one or more others of the secondary sulfur atoms. Strong bonds between the carbon and primary and secondary sulfur atoms hinder development and release of polysulfides that contribute to the shuttle effect. Some embodiments include various forms of binders and fillers that contribute some of the carbon in the sulfurized biocarbon. This additional carbon can be sourced from non-biological materials.

Biological materials contain nitrogen, a component of amino acids in plant structures, nucleic acids that form DNA, and chlorophyll. Nitrogen is used in the formation of sulfurized biocarbon because it aids in the formation of electrically conductive heterocyclic aromatic rings (HARs), ring-shaped molecular structures. HARs have Pi bonds in resonance (those containing delocalized electrons) that are more stable than other geometric or connective arrangements with the same set of atoms, and that confer improved electrical conductivity. In some embodiments, an inorganic source of nitrogen, such as polyacrylonitrile (PAN, (C₃H₃N)ₙ), can be used instead of or to supplement a biological source of nitrogen.

Methods of incorporating organic or inorganic sulfurized biocarbon into energy storage devices, e.g. to manufacture active electrode material for a cathode in a lithium-metal or lithium-ion cell, are detailed in U.S. patent application Ser. No. 17/430,594 (the '594 application) entitled “SULFURIZED-CARBON CATHODE WITH CONDUCTIVE CARBON FRAMEWORK,” filed 12 Aug. 2021 to Salvatierra et al. and incorporated herein by reference. The '594 application details how to make cathodes of sulfurized carbon for use in energy-storage devices. Some embodiments include in the cathode material a conductive framework of tangled nanofibers (e.g. carbon nanotubes) that bind active sulfurized-carbon materials while enhancing thermal and electrical conductivity. The conductive framework can also include at least one of graphene, graphene nanoribbons, graphene quantum dots, graphene oxide, and reduced graphene oxide.

Sulfurized biocarbon of the types detailed herein can be used as precursors or to make precursors for electrodes (e.g. cathodes) described in the '594 application. Such electrodes can include amorphous carbon-sulfur distributed within the tangled nanofiber, with most of the carbon atoms and most of the nitrogen atoms in the carbon-sulfur incorporated into heterocyclic aromatic rings that are bonded to the sulfur atoms via carbon-sulfur chemical bonds and to the nanofibers via chemical bonds. In some embodiments, the carbon precursors combined with carbon nanotubes consist primarily of biocarbon.

What follows is a non-exhaustive list of examples in which sulfurized biocarbon was produced using a readily available and recently living biological material, an “organic biocarbon.”

### Example 1: Sulfurized Biocarbon from Walnut Shell

Walnut shell was mixed with powdered elemental sulfur and a small amount of carbon additive (<5 wt % of total precursor mass). The mixture was reacted at 450° C. to obtain sulfurized carbon. In some embodiments, the walnut shell was dried and ground into a powder and mixed with sulfur and a small amount of carbon (<5 wt % of total precursor mass). In a control experiment, walnut shell was pyrolyzed at 700° C. to form carbon. The carbon was mixed with sulfur and pyrolyzed at 450° C. The product yielded a carbon material with only a small amount of sulfur (<5 wt % of total product mass). In contrast, the method of this example reacts sulfur with walnut shell that has not been extensively pre-pyrolyzed. Walnut shell contains lignans, low molecular weight organic polyphenols common in plants, that decompose in an inert atmosphere—pyrolyze—above about 300° C. (Other common polyphenols include tannins and ellagitannins.) The sulfur reacts with the walnut shell before the lignans are pyrolyzed so functional groups in the lignans react with the sulfur to yield organic, sulfurized biocarbon.

Pyrolysis destroys organic macromolecules and smaller biomolecules. Sulfurized biocarbon, sulfurized carbon made using products of living cells, can be distinguished from other forms of sulfurized carbon by carbon-14 dating. Carbon-14 is an isotope of carbon that accumulates at low levels in living cells. Carbon-14 has a half-life of 5,700 years and so is essentially absent from fossil fuels that have been buried for millions of years. Detectable levels of carbon-14, at present above 1% of the atmospheric level of carbon-14, are therefore indicative of carbon source from organic biocarbon. Sulfurized biocarbon in accordance with some embodiments includes a ratio of carbon-14 to carbon-12 that is more than 25% of the ratio in the atmosphere.

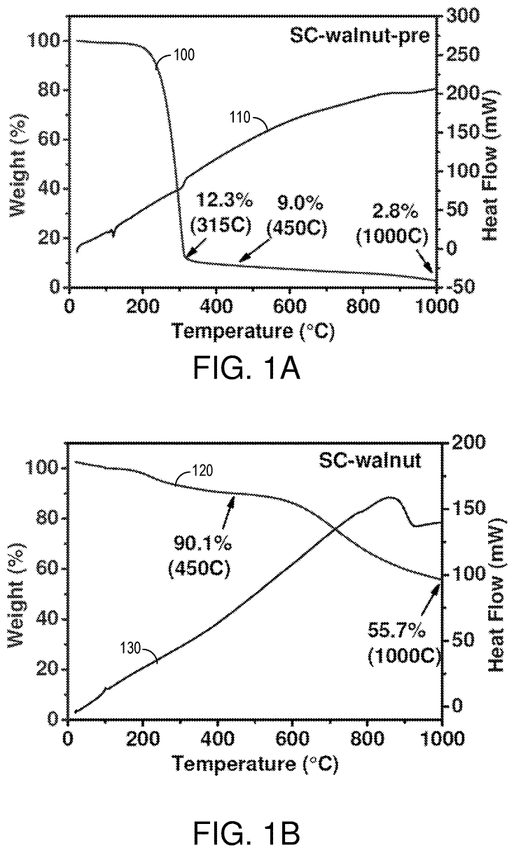

FIG. 1A includes a thermogravimetric (TG) plot 100 and differential scanning calorimetric (DSC) plot 110 of a biological precursor containing walnut shell as the predominant carbon source. FIG. 1B includes a TG plot 120 and DSC plot 130 of sulfurized biocarbon made from precursor containing walnut shell as the predominant carbon source.

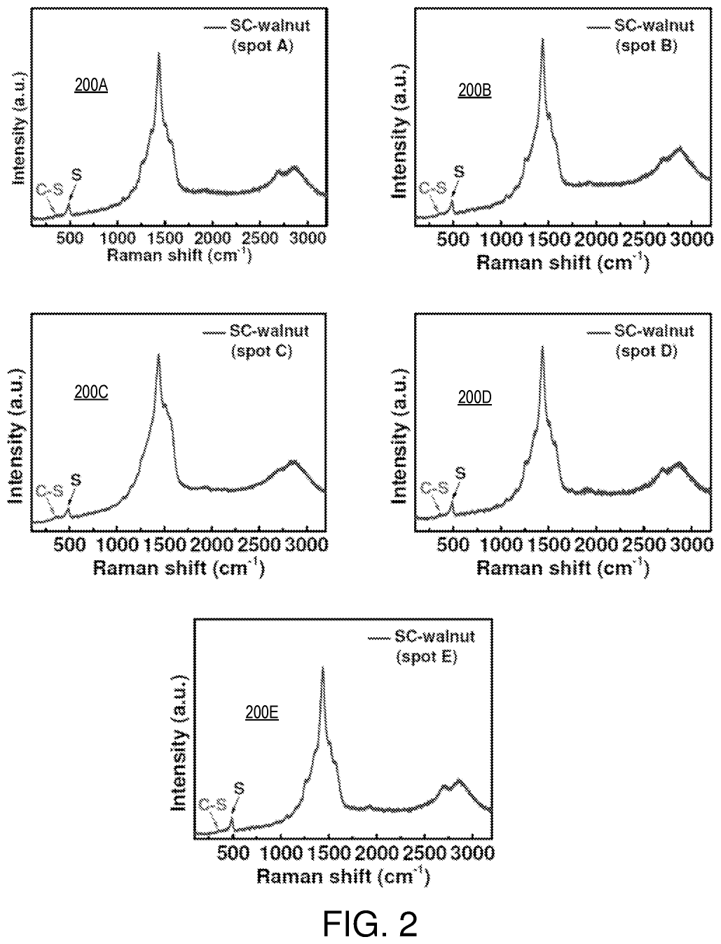

FIG. 2 depicts five Raman spectra 200A-200E of sulfurized biocarbon made from precursor containing walnut shell as the predominant carbon source. Each Raman spectrum is from a spatial sample spot or region of about 1-10 microns across. The collection of spots provides a comprehensive picture of the material.

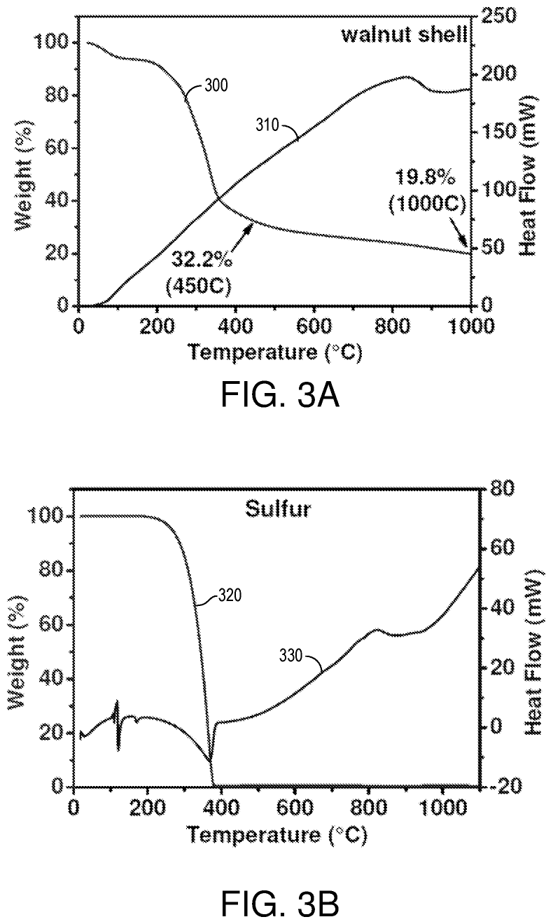

FIG. 3A includes a TG plot 300 and a DSC plot 310 of biomolecules made from walnut shell. FIG. 3B includes a TG plot 320 and DSC plot 330 of sulfur.

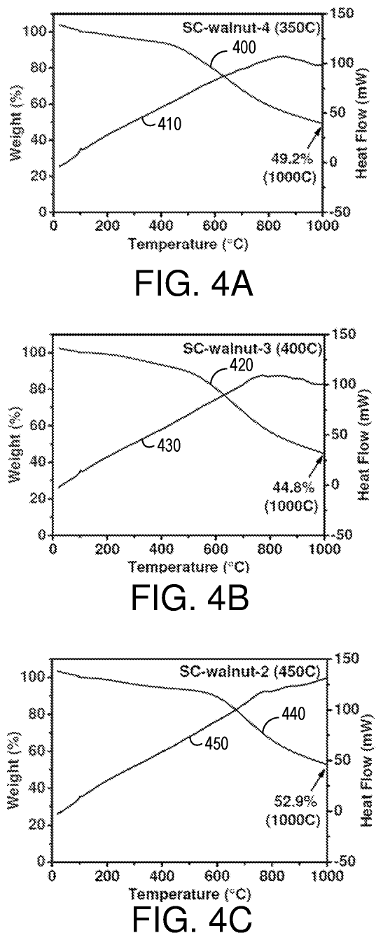

FIG. 4A includes a TG plot 400 and DSC plot 410 of sulfurized biocarbon made from precursor containing walnut shell as the predominant carbon source. The precursor did not contain carbon nanotubes. FIG. 4B includes a TG plot 420 and DSC plot 430 of sulfurized biocarbon made from precursor containing walnut shell as the predominant carbon source. The precursor did not contain carbon nanotubes. FIG. 4C includes a TG plot 440 and DSC plot 450 of sulfurized biocarbon made from precursor containing walnut shell as the predominant carbon source. The precursor did not contain carbon nanotubes.

### Example 2: Sulfurized Carbon from Onion

Onion (Allium cepa) is a vegetable of the genus, Allium. Here, it also includes several other species referred to as onions, such as the Japanese bunching onion, the tree onion, and the Canada onion. These vegetables are grown around the world and are used both as food flavoring and as a traditional medicine. The onion plant has leaves growing from a bulb at the base of the plant. The bulb consists of a globe-shaped, underground bud with membranous or fleshy overlapping leaves arising from a short stem. The onion's chemical constituents include organic macromolecules, polyphenols, vitamins, and minerals. Most of the carbon is found in “macromolecules,” which is defined herein to refer to one or a combination of carbohydrates, lipids, proteins, nucleic acids. Onion also includes smaller biomolecules, e.g. tear-inducing sulfoxides, that are likewise sources of carbon.

Onion is mixed with excess sulfur and a small amount of carbon additive (<5 wt % of total mixture mass). The mixture is reacted at 450° C. to obtain sulfurized carbon. In some embodiments, the bulb of the onion is dried and ground into a powder and mixed with sulfur and a small amount of carbon. The dried and ground onion can contain both the bulb and the skin. In some embodiments, the dried and ground onion contains the leaves. In some embodiments, only the skin is dried, ground, and mixed with sulfur and a small amount of carbon. In some embodiments, only the leaves are used. In a control experiment, the onion bulb or other component was dried, ground and pyrolyzed at 700° C. to form carbon. The carbon was mixed with sulfur and pyrolyzed at 450° C. The product yielded a carbon material with only a trace amount of sulfur. The method thus reacts sulfur with onion that has not been extensively pre-pyrolyzed (e.g. the onion has not been previously heated above 300° C. in the absence of added sulfur) and/or predominantly transformed to carbon because the functional groups of the biomolecules in the onion react with sulfur to yield sulfurized carbon. In some embodiments, the onion may be partially pyrolyzed but with many of its functional groups still present to react with sulfur. The functional groups include hydroxyl, vinyl, benzyl, carboxylic acid, ester, ketone, amide, sulfide, and sulfoxide.

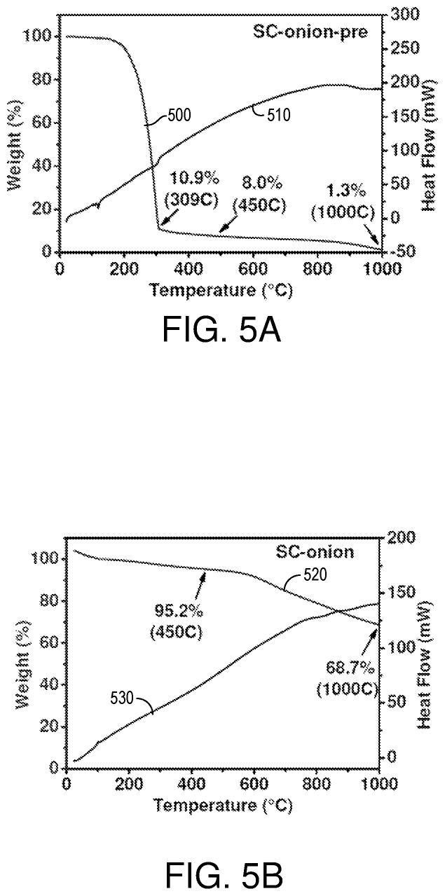

FIG. 5A includes a TG plot 500 and DSC plot 510 of a precursor containing onion as the predominant carbon source. FIG. 5B includes a TG plot 520 and DSC plot 530 of sulfurized biocarbon made from precursor containing onion as the predominant carbon source.

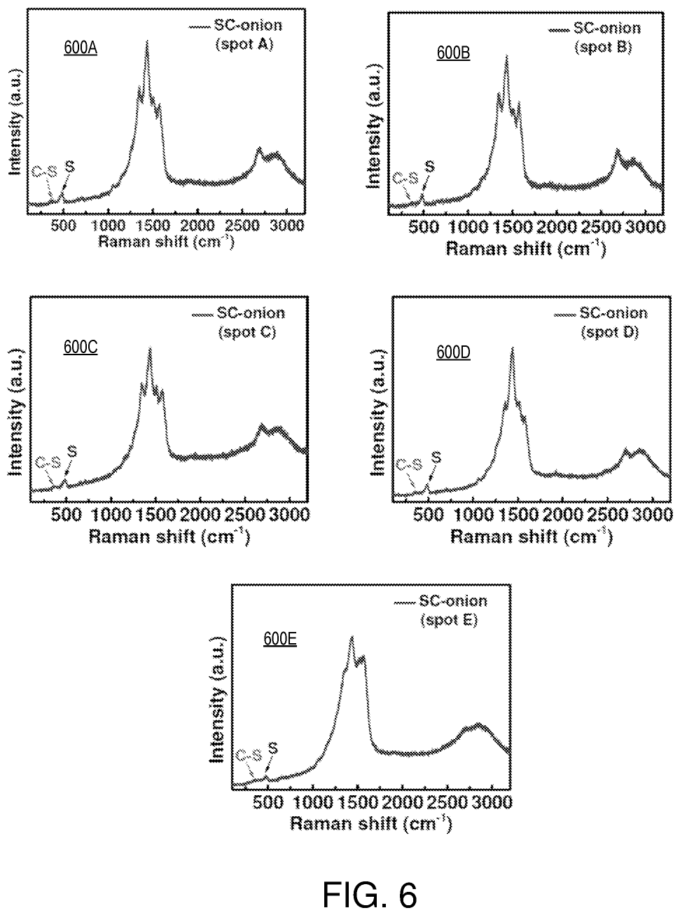

FIG. 6 depicts five Raman spectra 600A-600E of sulfurized biocarbon made from precursor containing onion as the predominant carbon source. Each Raman spectrum is from a spatial sample spot or region of about 1-10 microns across. The collection of spots provides a comprehensive picture of the material.

### Example 3: Sulfurized Carbon from Garlic

Garlic (Allium sativum) is a species of the onion genus, Allium. It is an herb grown around the world. It is used both a food flavoring and as a traditional medicine. It is a plant, growing from a bulb, which is odoriferous and contains other layers of thin sheathing leaves surrounding an inner sheath that encloses the clove. The bulb may contain 10-20 cloves. It is a plant whose chemical constituents include carbohydrates, lipids, fiber, amino acids, polyphenols, and minerals. Garlic is mixed with excess sulfur and a small amount of carbon additive. The mixture is reacted at 450° C. to obtain sulfurized carbon. In some embodiments, the bulb of the garlic is dried and ground into a powder and mixed with sulfur and a small amount of carbon. In some embodiments, the dried and ground garlic contains both the clove and the skin. In some embodiments, the dried and ground garlic contains both the clove, the inner and outer skin. In some embodiments, only the inner skin is dried, ground and mixed with sulfur and a small amount of carbon. In some embodiments, only the outer skin is used. In a control experiment, garlic cloves or other components of the plant were dried, ground and pyrolyzed at 700° C. to form carbon. The carbon was mixed with sulfur and pyrolyzed at 450° C. The product yielded a carbon material with only trace amount of sulfur. Thus, the method developed herein reacts sulfur with garlic that has not been extensively pre-pyrolyzed and/or predominantly transformed to carbon because the functional groups of the biomolecules in garlic react with sulfur to yield sulfurized carbon. In some embodiments, the garlic may be partially pyrolyzed but with many of its functional groups still present to react with sulfur. The functional groups include hydroxyl, vinyl, benzyl, carboxylic acid, ester, ketone, amide, sulfide, and sulfoxide.

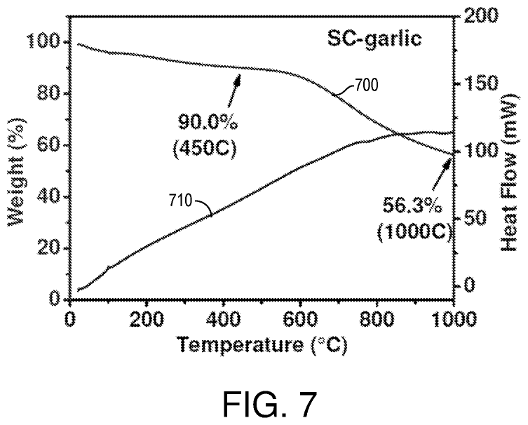

FIG. 7 includes a TG plot 700 and DSC plot 710 of sulfurized biocarbon made from precursor containing garlic as the predominant carbon source.

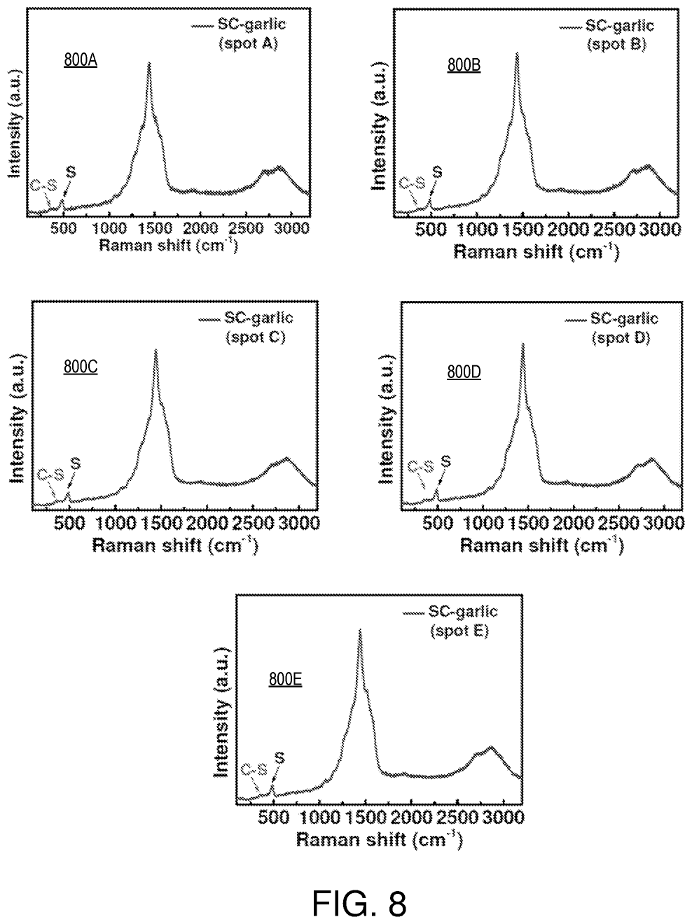

FIG. 8 depicts five Raman spectra 800A-800E of sulfurized biocarbon made from precursor containing garlic as the predominant carbon source. Each Raman spectrum is from a spatial sample spot or region of about 1-10 microns across. The collection of spots provides a comprehensive picture of the material. Peaks labeled C—S indicate carbon-sulfur chemical bonds. Peaks labeled S indicate sulfur-sulfur chemical bonds in a sulfur chain attached to the carbon. Thus, some of the sulfur atoms are bonded to only sulfur atoms (S—S) and some are bonded to both sulfur and carbon atoms (C—S—S).

### Example 4: Sulfurized Carbon from Coffee

Coffee (Coffea), a plant that belongs to the Rubiaceae family, genus Coffea, is perhaps the most commercialized food product and the most widely consumed beverage in the world. This includes Coffee arabica (Arabica coffee), Coffee canerora (Robusta coffee), and over 80 species known around the world. Coffee is a functional food, having a high content of compounds that have antioxidant and other beneficial biological activities. As a precursor for sulfurized carbon, the coffee seeds may be green, roasted, decaffeinated, steam-treated, and/or monsooned (cured). They may have extrinsic defects, such as stones, husks, and twigs that are mixed with fruits. They may also have intrinsic defects, which include black, sour, black-immature, and immature seeds. Coffee is a plant whose chemical constituents include carbohydrates, proteins, and nitrogen-containing compounds such as caffeine, lipids, fibers, polyphenols (e.g. lignin), minerals, acids, esters, and polycyclic aromatic hydrocarbons.

Coffee is mixed with excess sulfur and a small amount of carbon additive to produce a sulfurized-carbon precursor mixture. The mixture is reacted at 450° C. for 6 h to obtain sulfurized carbon. In some embodiments, coffee seeds are dried and ground into a powder and mixed with sulfur and a small amount of carbon. In some embodiments, the dried and ground coffee seeds are medium roasted. In some embodiments, they are dark roasted. In some embodiments, the coffee is spent coffee obtained as an insoluble byproduct of brewing. In a control experiment, the coffee seeds were ground and pyrolyzed at 700° C. to form carbon. The carbon was mixed with sulfur and pyrolyzed at 450° C. for 6 h. The product yielded a carbon material with only a trace amount of sulfur. Thus, the method developed herein reacts sulfur with coffee that has not been extensively pre-pyrolyzed. In some embodiments, the coffee may be partially pyrolyzed but with many of its functional groups still present to react with sulfur. The functional groups include hydroxyl, vinyl, benzyl, carboxylic acid, ester, ketone, amide, sulfide, and sulfoxide.

### Example 5: Sulfurized Carbon from Tea

Tea (Camellia sinensis) is a shrub known as Camellia sinensis. It is consumed as a beverage prepared by brewing cured or fresh leaves of the plant. Tea plant is an evergreen plant, propagated from seed and cuttings. There are two primary types: Camellia sinensis var. sinensis, which is used for most Chinese and Japanese teas, and C. sinensis var. assamica, which is used in Yunnan and most Indian teas. Tea includes white, yellow, green, Oolong, and dark tea. Tea's chemical constituents include carbohydrates, proteins and other nitrogen containing compounds such as caffeine, lipids, fibers, polyphenols (e.g. lignin), minerals, acids and esters, and polycyclic aromatic hydrocarbons.

To make sulfurized carbon, tea is mixed with excess sulfur and a small amount of carbon additive. The mixture is reacted at 450° C. for 6 h to obtain sulfurized carbon. In some embodiments, the tea comprises dried and ground leaves. In some embodiments, the tea is flavored with ingredients such as bergamot, vanilla, ginger, lemon, blueberry, raspberry, elderflower, cardamon, chamomile, hibiscus, cloves, peppermint, spearmint. In some embodiments, the tea comprises cured, ground leaves. In some embodiments, the tea is spent tea obtained as insoluble byproduct of brewing.

In a control experiment, tea or other component of the plant was dried, ground and pyrolyzed at 700° C. to form carbon. The carbon was mixed with sulfur and pyrolyzed at 450° C. The product yields a carbon material with only trace amount of sulfur. In contrast, the method developed herein reacts of sulfur with tea that has not been extensively pre-pyrolyzed. In some embodiments, the garlic may be partially pyrolyzed but with many of its functional groups still present to react with sulfur. The functional groups include hydroxyl, vinyl, benzyl, carboxylic acid, ester, ketone, amide, sulfide, and sulfoxide.

### Example 6: Sulfurized Carbon from Coffee Extract (Instant Coffee)

Some embodiments synthesize sulfurized carbon from extracts of biological materials. In one example, a commercially sourced Instant Coffee powder, which is a coffee extract, was mixed with excess sulfur and a small amount of carbon additive (<5 wt % of total precursor mass). The mixture was reacted at 450° C. to obtain sulfurized carbon. Extracts from biological materials may have organic macromolecules, but smaller biomolecules may be the predominant source of carbon.

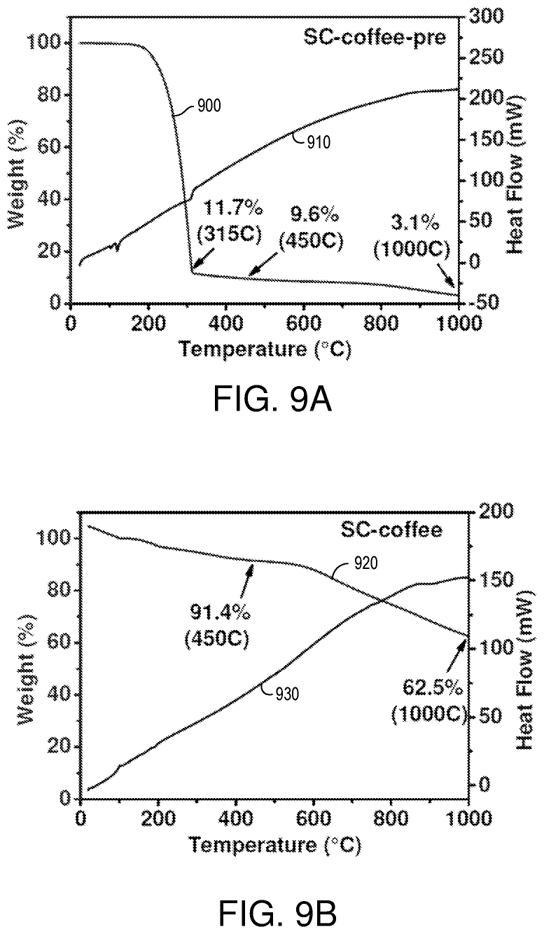

FIG. 9A includes a TG plot 900 and a DSC plot 910 of precursor containing coffee extract as the predominant source of carbon. FIG. 9B includes a TG plot 920 and DSC plot 930 of sulfurized biocarbon made from precursor containing coffee extract as the predominant carbon source.

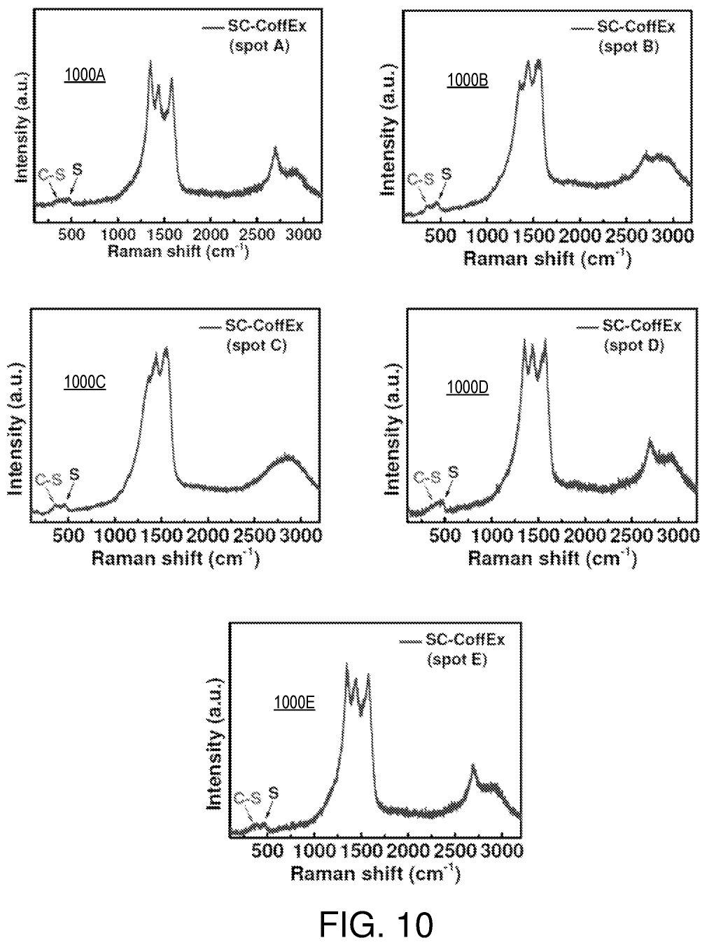

FIG. 10 depicts five Raman spectra 1000A-1000E of sulfurized biocarbon made from precursor containing coffee extract as the predominant carbon source. Each Raman spectrum is from a spatial sample spot or region of about 1-10 microns across. Peaks labeled C—S indicate carbon-sulfur chemical bonds. Peaks labeled S indicate sulfur-sulfur chemical bonds in a sulfur chain attached to the carbon. Thus, some of the sulfur atoms are bonded to only sulfur atoms (S—S) and some are bonded to both sulfur and carbon atoms (C—S—S).

### Example 7: Sulfurized Carbon from Collagen (an Essentially Protein Source)

A collagen powder was mixed with excess sulfur powder and a small amount of carbon additive (<5 wt % of total precursor mass). The mixture was reacted at 450° C. to obtain sulfurized carbon. The collagen composition was as follows:

TABLE 1
Composition for 20 g Hydrolyzed Collagen

| Constituent | Amount | |
|---|---|---|
| Calories | 70 | Cal |
| Protein | 18 | g |
| Sodium 65 mg | 1.933 | g |

TABLE 2
Typical Amino Acid Profile for 20 g Hydrolyzed Collagen

| | | |
|---|---|---|
| Alanine | 1.8 | g |
| Arginine | 1.587 | g |
| Aspartic acid | 1.127 | g |
| Glutamic acid | 1.933 | g |
| Glycine | 4.74 | g |
| Histidine* | 0.153 | g |
| Hydroxyproline | 2.28 | g |
| Isoleucine* | 0.304 | g |
| Leucine* | 0.58 | g |
| Lysine* | 0.76 | g |
| Methionine* | 0.172 | g |
| Phenylalanine* | 0.378 | g |
| Proline | 2.72 | g |
| Serine | 0.638 | g |
| Threonine* | 0.386 | g |
| Tyrosine | 0.113 | g |
| Valine* | 0.416 | g |

*Essential amino acids

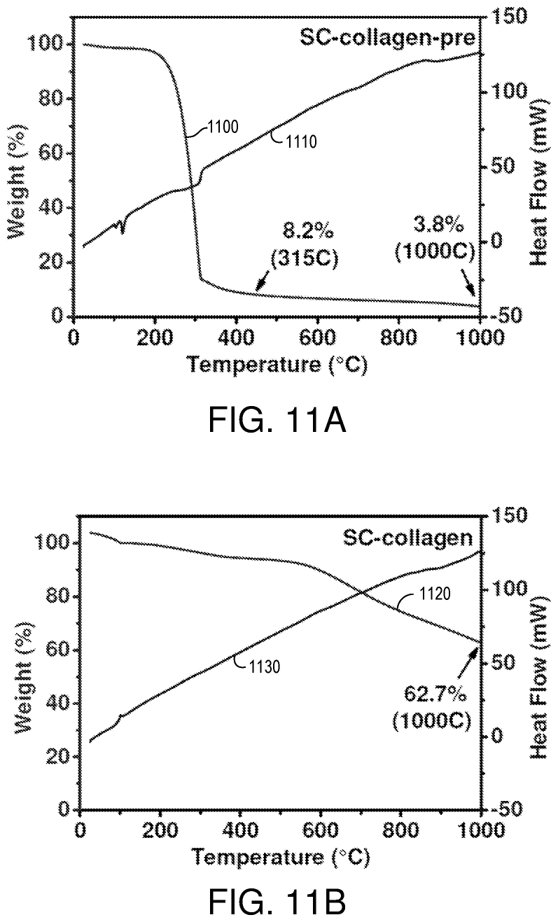

FIG. 11A includes a TG plot 1100 and DSC plot 1110 of a precursor containing collagen as the predominant carbon source. FIG. 11B includes a TG plot 1120 and DSC plot 1130 of sulfurized biocarbon made from precursor containing collagen as the predominant carbon source.

### Example 8: Sulfurized Carbon from Whey (a Predominantly Protein Source)

A whey powder was mixed with excess sulfur powder and a small amount of carbon additive (<5 wt % of total precursor mass). The mixture was reacted at 450° C. to obtain sulfurized carbon. The whey composition was as follows:

TABLE 3
Composition for 20 g Whey

| Constituent | Amount | |
|---|---|---|
| Calories | 120 | Cal |
| Total Fat | 0.5 | g |
| Cholesterol | 5 | mg |
| Total Carbohydrate | 6 | g |
| Dietary Fiber 2 g | | |
| Protein | 24 | g |
| Calcium | 175 | mg |
| Potassium | 100 | mg |
| Iron | 0.6 | mg |

TABLE 4
Whey Amino-Acid Profile
Typical amino acid profile, per 33 g whey*

| | | |
|---|---|---|
| Alanine | 1 | g |
| Arginine | 0.6 | g |
| Aspartic acid | 2.6 | g |
| Cystine | 0.5 | g |
| Glutamic acid | 4.2 | g |
| Glycine | 0.4 | g |
| Histidine | 0.5 | g |
| Isoleucine*\hat{ } | 1.75 | g |
| Leucine*\hat{ } | 2.8 | g |
| Lysine* | 2.68 | g |
| Methionine* | 0.5 | g |
| Phenylalanine* | 0.83 | g |
| Proline | 0.8 | g |
| Serine | 1 | g |
| Threonine* | 1.78 | g |
| Tryptophan* | 0.51 | g |
| Tyrosine | 0.7 | g |
| Valine*\hat{ } | 1.45 | g |

*Essential amino acids
\hat{ }Branched chain amino acids

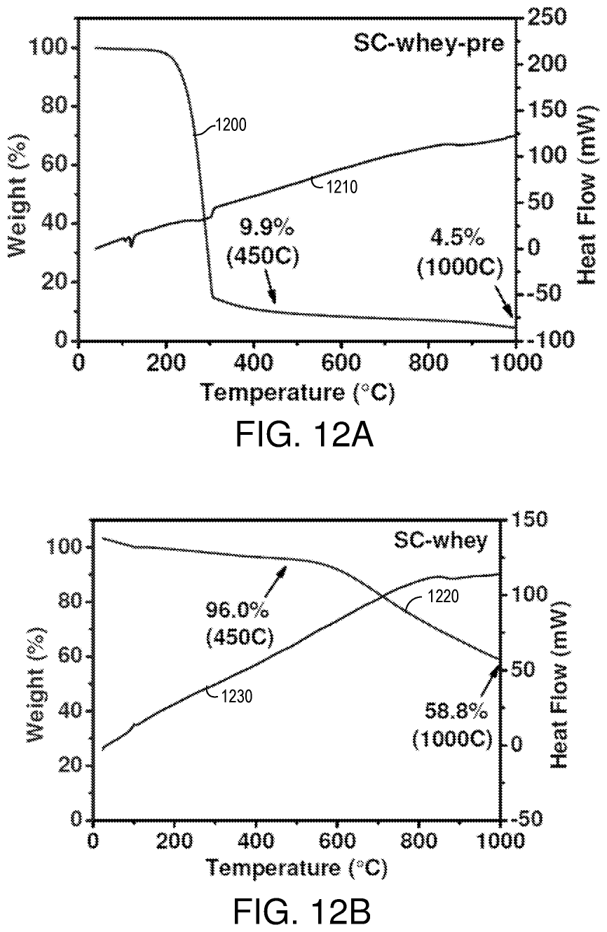

FIG. 12A includes a TG plot 1200 and DSC plot 1210 of a precursor containing whey as the predominant carbon source. FIG. 12B includes a TG plot 1220 and DSC plot 1230 of sulfurized biocarbon made from precursor containing whey as the predominant carbon source.

### Structure and Properties of Sulfurized Carbon

Sulfurized carbon made from walnut shell shows a mass loss of ˜10 wt % between 200-450° C., where the loss material is predominantly a mixture of (i) weakly bonded sulfur particles trapped inside sulfurized carbon pores or on carbon surface, (ii) strongly bonded sulfur particles trapped inside sulfurized carbon or on carbon, and (iii) sulfur bonded to other sulfur atoms. These relatively low temperature sulfur species are collectively designated as type I sulfur. In the (i) case, the sulfur, in the form of molecular clusters or particles, is weakly bonded (physisorbed) to the carbon walls or surfaces. This sulfur is predominantly evaporated below 300° C. during heating. In the (ii) case, the sulfur, in the form of molecular cluster or particle, is strongly bonded (chemisorbed) to the carbon at the carbon-sulfur interface. Much of the mass loss between 300-450° C. arises from the sulfur atoms at the carbon-sulfur interface, though other sulfur atoms in the particle may be evaporated at a lower temperature as described in (iii). In the (iii) case, the sulfur—a secondary sulfur atom or group of sulfur atoms—may be bonded to another sulfur—the primary sulfur atom—wherein the primary sulfur is either physisorbed or covalently bonded to the carbon at the interface. This sulfur is also predominantly evaporated below 300° C. during heating.

Another mass loss of ˜34 wt % that occurs >600° C. represents material that is made of predominantly bonded sulfur to carbon, which serves as the material framework. This sulfur is strongly bonded (typically covalently bonded), forming discrete carbon-sulfur bonds. This relatively high temperature sulfur is designated as type II sulfur. Unlike the physisorbed case (i) or chemisorbed case (ii), where a collection of sulfur atoms may be attached to a collection of carbon atoms, the covalently bonding in these carbon-sulfur bonds are discrete and identifiable as carbon-sulfur bonds via spectroscopic techniques, such as Raman spectroscopy. While secondary sulfur atoms may be attached to primary sulfur atoms that are directly attached to carbon, there are no more than a few secondary atoms, typically 1-4 atoms, instead of a sulfur particle. In some cases, a sulfur atom may be attached to more than one carbon atom, as in C—S—C. Also, sulfur atoms bonded to each other may also be separately bonded to carbon atoms, as in C—S—S—C, C—S—S—S—C, or C—S—S—S—S—C. The ratio of type II sulfur to type I sulfur is 3.5 in some embodiments. In other words, the sulfurized carbon comprises ˜77% type II sulfur.

Sulfurized carbon made from walnut shell shows a mass loss of ˜5 wt %<450° C., where the loss material is predominantly a mixture of (i) weakly bonded sulfur particles trapped inside sulfurized carbon pores or on carbon surface, (ii) strongly bonded sulfur particles trapped inside sulfurized carbon or on carbon, and (iii) sulfur bonded to other sulfur atoms. These relatively low temperature sulfur species are collectively designated as type I sulfur. In the (i) case, the sulfur, in the form of molecular clusters or particles, is weakly bonded (physisorbed) to the carbon walls or surfaces. This sulfur is predominantly evaporated below 300° C. during heating. In the (ii) case, the sulfur, in the form of molecular cluster or particle, is strongly bonded (chemisorbed) to the carbon at the carbon-sulfur interface. Much of the mass loss between 300-450° C. arises from the sulfur atoms at the carbon-sulfur interface, though other sulfur atoms in the particle may be evaporated at a lower temperature as described in (iii). In the (iii) case, the sulfur—a secondary sulfur atom or group of sulfur atoms—may be bonded to another sulfur—the primary sulfur atom—wherein the primary sulfur is either physisorbed or covalently bonded to the carbon at the interface. This sulfur is also predominantly evaporated below 300° C. during heating.

Another mass loss of ˜27 wt % that occurs >600° C. represents material that is made of predominantly bonded sulfur to carbon, which serves as the material framework. This sulfur is strongly bonded (typically covalently bonded), forming discrete carbon-sulfur bonds. This relatively high temperature sulfur is designated as type II sulfur. Unlike the physisorbed case (i) or chemisorbed case (ii), where a collection of sulfur atoms may be attached to a collection of carbon atoms, the covalently bonding in these carbon-sulfur bonds are discrete, identifiable carbon-sulfur bonds via spectroscopic techniques, such as Raman spectroscopy. While secondary sulfur atoms may be attached to primary sulfur atoms that are directly attached to carbon, there are no more than a few secondary atoms, typically 1-4 atoms, instead of a sulfur particle. In some cases, a sulfur atom may be attached to more than one carbon atoms, as in C—S—C. Also, sulfur atoms bonded to each other may also be separately bonded to carbon atoms, as in C—S—S—C, C—S—S—S—C, or C—S—S—S—S—C. The ratio of type II sulfur to type I sulfur is 5. In other words, the sulfurized carbon comprises ˜84% type II sulfur.

Another mass loss of ˜29 wt % that occurs >600° C. represents material that is made of predominantly bonded sulfur to carbon, which serves as the material framework. This sulfur is strongly bonded (typically covalently bonded), forming discrete carbon-sulfur bonds. This relatively high temperature sulfur is designated as type II sulfur. Unlike the physisorbed case (i) or chemisorbed case (ii), where a collection of sulfur atoms may be attached to a collection of carbon atoms, the covalently bonding in these carbon-sulfur bonds are discrete, identifiable carbon-sulfur bonds via spectroscopic techniques, such as Raman spectroscopy. While secondary sulfur atoms may be attached to primary sulfur atoms that are directly attached to carbon, there are no more than a few secondary atoms, typically 1-4 atoms, instead of a sulfur particle. In some cases, a sulfur atom may be attached to more than one carbon atoms, as in C—S—C. Also, sulfur atoms bonded to each other may also be separately bonded to carbon atoms, as in C—S—S—C, C—S—S—S—C, or C—S—S—S—S—C. The ratio of type II sulfur to type I sulfur is 3. In other words, the sulfurized carbon comprises ˜76% type II sulfur.

The sulfurized biocarbon contains nitrogen atoms, which form heterocyclic aromatic rings with the carbon atoms. The rings could be five-, six-, or seven-membered rings of between e.g. 2 nm and 20 nm in diameter. In some embodiments, most of the carbon atoms and most of the nitrogen atoms in the sulfurized carbon are locked in heterocyclic aromatic rings. Replacing one or more of the carbons in an aromatic ring with a nitrogen atom affect the ring's aromaticity and reactivity. Aromaticity is the property of a cyclic compound in which the conjugated (altering single and double bonds) molecule is stabilized by the delocalization of the pi electrons. The heterocyclic rings in the sulfurized biocarbon are fused to form polyaromatic clusters, a cluster being a group of rings in which two adjacent rings share one or more atoms. These clusters are covalently linked to form particles. In some embodiments, a majority (most, or more than half) of the particles are between 0.5 μm and 30 μm diameter. The particles in turn form agglomerates, most of which are between 2 μm and 60 μm in some embodiments. Nitrogen can be incorporated into the aromatic carbon without breaking the aromaticity, which is a source of electrical conductivity. Oxygen atoms form defects by causing the sulfurized carbon to lose aromaticity and decreasing the sizes of polyaromatic clusters, particles, and/or agglomerates. Thus, relatively nitrogen-rich precursor compounds are more favorable toward formation of sulfurized biocarbon. In some embodiment, most of the rings incorporate at least one of the nitrogen atoms. The presence of heterocyclic aromatic rings with carbon and nitrogen can be detected using nuclear magnetic resonance (NMR) or Raman spectroscopy.

The foregoing examples are by no means exhaustive. Biological materials for use as carbon sources are ubiquitous. Moreover, sulfur supplied as powdered elemental sulfur (e.g. at least 90 wt % elemental sulfur) in some of the foregoing embodiments, can be replaced or supplemented with sulfur compounds (e.g., gaseous, liquid, or solid petroleum fractions) and biological sulfur-containing compounds (e.g., some amino acids, proteins, lipids, carbohydrates, and metabolites). Moreover, organic sources of sulfur and carbon can be supplemented or replaced with inorganic ones in the making of sulfurized carbon. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. Sulfurized carbon comprising:
carbon atoms;
nitrogen atoms;
clustered heterocyclic aromatic rings incorporating most of the carbon atoms in the sulfurized carbon and most of the nitrogen atoms in the sulfurized carbon;
primary sulfur atoms, each primary sulfur atom adjacent to at least one of the carbon atoms, wherein most of the primary sulfur atoms are covalently bonded to at least one of the carbon atoms via a carbon-sulfur bond; and
secondary sulfur atoms, each secondary sulfur atom separated from each of the carbon atoms by at least one intervening atom.

2. The sulfurized carbon of claim 1, wherein the carbon comprises a biocarbon.

3. The sulfurized carbon of claim 1, wherein most of the heterocyclic aromatic rings include at least one of the nitrogen atoms.

4. The sulfurized carbon of claim 1, wherein the carbon atoms, the primary sulfur atoms, and the secondary sulfur atoms have a combined weight; and the primary sulfur atoms and the secondary sulfur atoms have a sulfur weight greater than 10 wt % of the combined weight.

5. The sulfurized carbon of claim 1, wherein the nitrogen atoms comprise between 1 wt % and 10 wt % of the sulfurized carbon.

6. The sulfurized carbon of claim 1, wherein most of the heterocyclic aromatic rings have a size between 2 nm and 20 nm.

7. The sulfurized carbon of claim 1, wherein the heterocyclic aromatic rings are covalently bonded to form particles.

8. The sulfurized carbon of claim 7, wherein a majority of the particles have a size between 0.5 μm and 30 μm.

9. The sulfurized carbon of claim 1, wherein the particles form agglomerates.

10. The sulfurized carbon of claim 9, wherein a majority of the agglomerates have a size between 2 μm and 60 μm.

11. The sulfurized carbon of claim 1, wherein the carbon atoms include carbon-14 atoms and carbon-12 atoms at a ratio of the carbon-14 atoms to the carbon-12 atoms of 1.25/10E12.

12. The sulfurized carbon of claim 1, wherein the primary sulfur atoms outnumber the secondary sulfur atoms.

13. The sulfurized carbon of claim 12, wherein a majority of the secondary sulfur atoms are covalently bonded to at least one of the primary sulfur atoms or secondary sulfur atoms via a sulfur-sulfur bond.

14. The sulfurized carbon of claim 1, wherein a portion of the carbon atoms are arranged in at least one of carbon nanotubes, graphene, graphene nanoribbon, graphene quantum dots, graphene oxide, and reduced graphene oxide.

15. A method of making sulfurized biocarbon, the method comprising
heating at least one biological material with sulfur, each biological material comprising organic macromolecules, to a temperature of at least 300° C.;
wherein the biological material is sulfurized as it reacts with the sulfur, pyrolyzed and converted to the sulfurized biocarbon, and wherein the sulfurized biocarbon comprises:
carbon atoms;
nitrogen atoms;
heterocyclic aromatic rings incorporating most of the carbon atoms and most of the nitrogen atoms;
primary sulfur atoms adjacent the carbon atoms; and
secondary sulfur atoms separate from the carbon atoms by at least one intervening atom;
wherein a majority of the primary sulfur atoms are covalently bonded to the adjacent carbon atoms via carbon-sulfur bonds; and
wherein the primary sulfur atoms in combination with the secondary sulfur atoms are greater than 10% of the sulfurized biocarbon by weight.

16. The method of claim 15, wherein the aromatic rings incorporate most of the wherein the biological material consists predominantly of the organic macromolecules.

17. The method of claim 15, further comprising producing the at least one biological material before the heating by pre-heating a biological precursor with functional groups to a temperature below 300° C. to decompose at least one of its functional groups.

18. An electrode comprising:
amorphous carbon-sulfur including:
carbon atoms, sulfur atoms, and nitrogen atoms;
wherein most of the carbon atoms and most of the nitrogen atoms are incorporated into heterocyclic aromatic rings; and
the sulfur atoms are bonded to the heterocyclic aromatic rings via carbon-sulfur chemical bonds.

19. The electrode of claim 18, wherein most of the heterocyclic aromatic rings include at least one of the nitrogen atoms.

20. The electrode of claim 18, further comprising a conductive framework of tangled nanofibers extending through the carbon-sulfur.

21. The electrode of claim 18, wherein the carbon atoms are primarily biocarbon.
